(19) United States
(12) Patent Application Publication
(10) Pub. No.: US 2012/0109688 A1
(43) Pub. Date: May 3, 2012

(54) INTERNET PHONE APPARATUS INCLUDING BIOLOGICAL ANALYSIS DEVICE AND A REMOTE MEDICAL-SERVICE METHOD USING THE SAME

(75) Inventor: Jae Chern Yoo, Gwacheon-si (KR)

(73) Assignee: SAMSUNG ELECTRONICS CO., LTD., Suwon-si (KR)

(21) Appl. No.: 13/256,374

(22) PCT Filed: Mar. 26, 2010
(86) PCT No.: PCT/KR10/01874

§ 371 Date: Jan. 10, 2012

(30) Foreign Application Priority Data
Mar. 30, 2009 (KR) 10-2009-0027896
Mar. 15, 2010 (KR) 10-2010-0022761

(51) Int. Cl. G06Q 50/24

(52) U.S. Cl. 705/3

(57) ABSTRACT

Disclosed are an internet phone apparatus including a biological analysis device and a remote medical service method using the same. The biological analysis device is built in the internet phone apparatus. The internet phone apparatus transmits measurement data obtained from the biological analysis device to a remote doctor through an internet network and outputs medical service data as the medical service data are received from the remote doctor through the internet network. The internet phone apparatus including the biological analysis device and the remote medical service method using the same realize an effective remote medical diagnosis.

### TECHNICAL FIELD

The present invention relates to an internet phone capable of analyzing bio materials. More particularly, the present invention relates to an internet phone apparatus including a biological analysis device for analyzing bio materials and a remote medical-service method using the same.

### BACKGROUND ART

An internet phone provides a new phone service, in which a phone terminal is connected to a worldwide internet line, instead of a phone line, to form an internet-based voice communication network managed by an ISP (internet service provider). The internet phone is a phone that wireless/wired internet is available and generally called “VoIP (voice over internet protocol) phone” or “IP (internet protocol) phone”. In such an internet phone, an analog voice signal is converted into a digital data signal so that the signal is transmitted to a counterpart as internet data. Thus, the voice is recognized as data so that the voice is processed similarly to the internet data. However, the conventional internet phone cannot analyze bio materials and provide a remote medical diagnosis service. According to the conventional remote medical analysis method, a patient can make contact with a doctor through an internet network connected to a user computer. However, the conventional remote medical analysis method requires the user computer connected to the internet network and medical devices must be connected to the user computer.

According to conventional remote medical diagnosis methods, the medical devices must be connected to the user computer through input/output terminals to perform various types of diagnosis, so that lines of the medical devices are entangled with lines of a mouse and a keyboard, resulting in the complicated user interface. In order to commercialize and effectively perform the remote medical diagnosis method, there is required a medical device capable of providing the patient with a user interface which is easy to handle at home. That is, according to conventional remote medical diagnosis methods, a plurality of medical devices, such as a stethoscope, a thermometer, an image sensor, an ultrasonic scanning apparatus, and a blood analysis device, must be additionally connected to the input/output terminals of the user computer in use. In addition, the user must store the medical devices by separating the medical devices from the input/output terminals of the user computer after use, causing inconvenience to the user. Otherwise, the lines of the medical devices are entangled with lines of the mouse and the keyboard, so that ambient environment of the computer becomes complex, causing inconvenience to the user. In this case, environment of the user performing the remote medical diagnosis is messy and complicated. Therefore, there is necessary to provide a remote medical diagnosis device and a remote medical service method, capable of providing a user interface that is easy to handle by the user, in which a biological analysis device is built in an internet phone so that the diagnosis result is displayed through a display unit of the internet phone, and measurement data of the biological analysis device are directly transmitted to a remote medical diagnosis server, which relays connection between a remote doctor and the biological analysis device through the internet phone, between a hospital server and the biological analysis device through the internet phone, or between a computer of the remote doctor and the biological analysis device through the internet phone, thereby effectively performing the remote medical diagnosis.

### DISCLOSURE OF INVENTION

### Technical Problem

According to one aspect, an object of the present invention is to provide an internet phone equipped with a biological analysis device for analyzing bio materials and a remote medical-service method using the same.

### Solution to Problem

In this specification, a “bio disc” may include a bio disc, a digital bio disc, a thin film chemical analysis device or a bio memory disc having a semiconductor memory mounted on a bio disc, on which a lab-on-a-chip is integrated so as to be applied to a variety of diagnostic analysis devices such as a nucleic acid hybridization analysis device, a bio material analysis device, a device analyzing a patient's constitution for personalized medicine, a urea analysis device, a blood analysis device, an environmental pollution (air pollution, water pollution, food-born pathogen) analysis device, a biochemical analysis device, or an immunoassay device.

A “bio disc drive” is a device which controls operations of a bio disc and measuring and analyzing the data by allowing loading, inserting, mounting, detaching or integrating of the bio disc.

A “biochip” includes a DNA chip, a lab-on-a-chip, a protein chip, a rapid test kit or a test strip, but not limited thereto.

A “biochip analysis device” is an apparatus which measures data and determines results of the data by allowing loading, inserting, mounting, detaching or integrating of the biochip.

A “biological analysis device” includes the bio disc drive and/or the biochip analysis device.

A “medical device” includes a thermometer used for medical examination and treatment, a sphygmomanometer, a camera, a stethoscope, a body composition analyzer, an arteriosclerosis detector, an ultrasonic scanning apparatus, an urianalyzer, a pulse monitor, a blood sugar meter, a blood sampling device, an electrocardiogram, an X-Ray apparatus, an oxymeter, a dementia detecting apparatus, a computerized axial tomography (CAT) apparatus, a magnetic resonance imaging (MRI) apparatus, a capsule endoscopy, a magnifier, a magnifier with a camera, a medical instrument, a bio signal detecting apparatus, and a bio shirt having a function of detecting a bio signal (diabetes, obesity, blood pressure, pulse, an electrocardiogram, body temperature, or the like).

A “virtual doctor” includes a doctor residing as software in the internet phone to provide a user with guidelines and instructions as how to use the biological analysis device or to output the diagnosis result by self-analyzing the measurement data through mathematical calculation.

According to one embodiment of the present invention, there is provided an internet phone apparatus including an internet phone connected to a wired internet or a wireless internet to transmit/receive information related to a medical service or a voice signal, a tray allowing loading of the bio disc or an optical disc, a motor for rotating the bio disc or the optical disc loaded in the tray and a bio disc drive for controlling the motor.

According to one embodiment of the present invention, the internet phone apparatus may further include a user computer connected through a wired connection unit or a wireless connection unit to provide a graphic user interface (GUI) for controlling a biological analysis device built in the internet phone apparatus.

According to one embodiment of the present invention, the internet phone apparatus may further include a monitor connected through a wired connection unit or a wireless connection unit to provide a GUI screen for the biological analysis device.

The connection unit is selected from the group consisting of a universal serial bus, infrared communication, RF communication, wired/wireless internet, a fixing unit providing the wired/wireless internet, and a Bluetooth. The user computer transmits a control command to the internet phone apparatus through the connection unit in order to drive and control the biological analysis device.

The internet phone apparatus may further include a barcode reader for reading a barcode provided in the bio disc or the biochip. Preferably, the barcode includes a product ID of the bio disc or the biochip.

The internet phone apparatus may further include an RF ID (radio frequency identification) reader for reading an animal RF ID or an ID and contents of an RF IC provided in the medical device, the bio disc or the biochip.

The RF ID reader may include an authentication unit for authenticating the medical device, the biochip, or the bio disc and a recording unit for recording measurement data in the RF IC.

According to the present invention, preferably, the recording unit receives a cumulative history of past diagnosis results made by the virtual doctor or the remote doctor from the remote medical diagnosis server and saves the cumulative history into the RF IC.

According to the present invention, a password (personal ID and personal password) used for signing up and authentication procedure is stored in the RF IC so that the bio disc and biochip can be personally encrypted.

The password (personal ID and personal password) is transmitted to the remote medical diagnosis server such that the password is stored in the remote medical diagnosis server. Preferably, the password is used upon accessing the remote medical diagnosis server through the GUI or the internet phone.

An animal RF ID is implanted to the animal or attached to the skin of the animal and includes a unique identification number for each animal. The RF ID and the RF IC are made based on international standards, such as ISO 11784 and ISO 11785, which are well known in the art, or the modifications thereof. Since encrypted personal information and the product ID are stored in the RF IC, the bio disc and information of the bio disc are not available for a non-authorized person.

In addition, information on species, age, place of origin, etc., of the animal is recorded to a tag which is attached to the animal RF ID, and thus, the information may be identified by a wireless RF ID reader. Since the history of an animal can be tracked using the animal RF ID, when an animal disease such as mad cow disease, foot-and-mouth disease, bird flu, etc., occurs, efficient measures for the disinfection of the animal may be taken within a short period of time. Information on the raising, slaughtering of the animal and the processing and circulation of the meat of the animal can be obtained and be accurately revealed to customers. The animal RF ID can also be applied to agricultural products and a food history tracking system, thereby providing customers with accurate information on foods.

The internet phone apparatus may further include a memory unit for storing measurement data obtained from the biological analysis device and product information selected from the group consisting of a version, a date of manufacture, and a product ID of the biological analysis device. The measurement data stored in the memory unit can be transmitted to a hard disc drive (HDD) so as to be stored therein. The measurement data can also be transmitted to the remote doctor or the remote medical diagnosis server.

The product ID of the biological analysis device stored in the memory unit is provided to the remote medical diagnosis server through an internet network for product authentication of the biological analysis device. In detail, the remote medical diagnosis server performs the product authentication for the biological analysis device by comparing the product ID with the ID of the genuine product stored in the database.

If the authentication of the product ID fails, the operation of the biological analysis device is preferably deactivated.

According to the present invention, the bio disc or the biochip is preferably authenticated by the biological analysis device that passes the product authentication. In this case, the RF IC reader reads product information from the RF IC on the bio disc or the biochip regardless of off-line connection or internet connection to authenticate the bio disc or the biochip.

The product ID may be a serial number of the product, and the biological analysis device which fails authentication may not operate since operational software cannot be downloaded from the remote medical diagnosis server.

The internet phone apparatus is upgraded by automatically downloading driving software corresponding to the product ID of the biological analysis device. The internet phone apparatus can transmit barcode information on the bio disc, the product ID of the bio disc, the product ID of the biological analysis device, an animal RF ID or the measurement data to the remote medical diagnosis server through the internet. The internet phone apparatus may further include animal identification software that authenticates an identification of the animal by transmitting the animal RF ID to an animal RF ID management server. The internet phone apparatus may further include an interface unit that enables connection to a local server for remote communication, a home network system or a home network system cooperating with household appliances, or may include the server and systems. The internet phone apparatus can be connected to the medical device through the connection unit to transmit the medical data of the patient obtained from the medical device to the remote doctor. In addition, the internet phone apparatus is connected to a mouse and a monitor providing a GUI screen through the connection unit to drive or control the bio analysis device as the user selects the menu displayed on the GUI screen by moving and clicking the mouse. The internet phone apparatus may further include a sample detection unit that transmits a command for automatically ejecting or unloading the bio disc or the biochip or sends a warning message to the user if the bio disc or the biochip is loaded on the biological analysis device without a sample. The internet phone apparatus may further include a bio disc validity checking unit that transmits a command for automatically ejecting or unloading a bio disc from the biological analysis device or sends a warning message to the user when the bio disc is unidentified by the bio drive, a previously used bio disc is loaded, or the valid period of the bio disc is over. The internet phone apparatus may further include a biochip validity checking unit that transmits a command for automatically ejecting or unloading the biochip from the biological analysis device or sends a warning message to the user when the biochip is unidentified by the biochip analysis apparatus, a previously used biochip is loaded or the valid period of the biochip is over. If the user requests for an assay stop or an unloading of the bio disc or the biochip while the bio disc or the biochip is analyzing the sample, the internet phone apparatus may include an assay stop process unit which keeps processing the analysis, sends a warning message to the user, or demands for login information (personal ID and password). That is, the assay stop process unit transmits a command for ejecting or unloading the bio disc or the biochip from the biological analysis device, if the password is correct in order to accept the request for the unloading or the assay stop by the user, and if the user requests for an assay stop or an unloading of the bio disc or the biochip while the bio disc or the biochip is analyzing the sample. If the assay of the bio disc or the biochip is stopped by the password, the assay stop may be included in the history management list to be stored in the RF IC or stored in the remote medical diagnosis server. The biological analysis device can be controlled in real time by the remote doctor if the control right is assigned to the remote doctor. Since the biological analysis device can be controlled in real time by the remote doctor, the remote doctor can easily provide the medical service to a user even if the user is not accustomed with the biological analysis device. The term “assignment of control right” means that the remote control right for the internet phone apparatus is assigned to the remote doctor. Thus, the remote doctor who obtains the remote control right can control the operation of the GUI or the biological analysis device, can directly transmit the command to the internet phone apparatus to control the operation of the biological analysis device, or can monitor the operation of the biological analysis device in real time.

The internet phone apparatus may include a control assignment button to assign the remote control right for the biological analysis device to the remote doctor. The bio disc may include at least one selected from the group consisting of a disease diagnosis assay device, a nucleic acid hybridization analysis device, a bio material analysis device, a device analyzing a patient's constitution for personalized medicine, a urea analysis device, a blood analysis device, an environmental pollution analysis device, a biochemical analysis device, and an immunoassay device. For instance, the bio disc may include a bio disc, a digital bio disc, a thin film chemical analysis device or a bio memory disc, on which a lab-on-a-chip is integrated so as to be selectively applied to a variety of diagnostic analysis devices such as a nucleic acid hybridization analysis device, a bio material analysis device, a device analyzing a patient's constitution for personalized medicine, a urea analysis device, a blood analysis device, an environmental pollution (air pollution, water pollution, food-born pathogen) analysis device, a biochemical analysis device, or an immunoassay device.

The bio disc includes a valve for controlling a fluid flow essential to the lab-on-a-chip and an analysis device for analyzing bio materials, such as materials subject to environmental inspection. In addition, the biological analysis device may include a lab-on-a-chip employing enzyme-linked immunosorbent assay (ELISA), a lab-on-a-chip employing a rapid test; a lab-on-a-chip for inspecting food-born pathogens, residual antibiotics, residual agrichemicals, gene manipulated food, air pollution, water pollution, food allergy, paternity, meats and place of origin of the meat; and a small-sized or thin film analyzer diagnosing and detecting a small amount of bio-materials or chemicals in a fluid. The biological analysis device may qualitatively and quantitatively analyze blood, urea, or bio-materials so as to perform various disease-related tests to detect cancer, blood sugar, blood type, body fat, obesity, viscosity of blood, blood pressure, cardiovascular diseases, oxygen saturation in blood, a patient's constitution for personalized medicine, Alzheimer's, dementia, liver disease, myocardial infarction, AIDS, environmental pollution, venereal diseases, pregnancy, genetic diseases, cholesterol, GOT, GPT, or the like. For instance, the water pollution may be measured by analyzing the degree of heavy metal pollution, the concentration of bacteria, etc., in water. Pollutions by organic mercury, a cyan compound, organic phosphorus, cadmium, arsenic, phenol, copper, lead, and chrome are analyzed to measure the heavy metal pollution. The content of SO2, dust (TSP), carbon monoxide (CO), nitrogen dioxide (NO2), hydrocarbon (HC), ozone (O3), lead (Pb) in the air may be analyzed to measure the air pollution. In the analysis of urea, the biological analysis device may analyze leucocyte, blood, protein, nitrite, pH, specific gravity, glucose, ketone, ascorbic acid, urobilinogen, bilirubin, body fat, or blood pressure. The biomaterials may be selected from the group consisting of DNA, oligonucleotide, RNA, PNA, ligand, a receptor, an antigen, an antibody, milk, urea, saliva, hair, an agricultural sample, a plant sample, a meat sample, a fish sample, a bird sample, sewage (contaminated water), a livestock sample, a food sample, foodstuffs, storage food, oral cell, a tissue sample, sperm, protein, or other living materials. In addition, the bio disc may include a memory embedded wireless RF IC (or electronic tag) in order to store a protocol for a lab-on-a-chip, an assay algorithm, standard control values for assaying, positional information on assay sites, bioinformatics information, information related to self-diagnosis, bio disc driver software, educational information on clinical assays for patients, a variety of web sites and links enabling a patient to communicate with a doctor or a hospital at a remote location based on the diagnosis result, encrypted personal information, history, or the like. The internet phone apparatus may further include a medical information reading unit which reads information from the RF IC or the remote medical diagnosis server and provides the user with the information selected from the group consisting of a type, a version, a date of manufacture, and a validity period of the bio disc or the biochip loaded on the biological analysis device, a diagnosable disease list, user precautions, details of a history management list, medical data, and next examination date.

According to another aspect, the internet phone apparatus of the present invention may further include an information access unit which transmits a product ID or a product serial number read from the RF IC of the bio disc or the biochip loaded on the biological analysis device to the remote medical diagnosis server, and receives information corresponding to the product ID or the product serial number from the remote medical diagnosis server to provide a user with the information selected from the group consisting of a type, a version, a date of manufacture, and a validity period of a product, a diagnosable disease list, user precautions, details of a history management list, medical data, and next examination date. That is, the information access unit provides the user with information read from the RF IC, such as medical data, details of a history management list, and next examination date, through on-line when the used bio disc or the used biochip is loaded on the biological analysis device.

In order to allow access to the information, the information access unit performs a password authentication process for the password stored in the remote medical diagnosis server. The details of history management list may include past diagnosis results, a past disease history, and tracked management contents.

The diagnosis results made by the remote doctor and the virtual doctor and the ID of the remote doctor are stored in the RF IC.

Therefore, it is possible to know the doctor who performs the remote medical diagnosis based on the ID of the remote doctor. The bio disc drive may include a device which controls and drives the bio disc and measures and analyzes the result by allowing loading, inserting, mounting, detaching or integrating of the bio disc. Thus, the internet phone apparatus can measure and analyze data from an assay site of the bio disc using a bio sensor or a detector combined with a converter, which includes an optical measurement device, an electrochemical measurement device, a fluorescent measurement device, an impedance measurement device, or an image sensor device installed in the biological analysis device. The analyzed information can be transmitted/received through the internet network as digital information, thereby providing the remote medical diagnosis service to doctors and patients. In detail, the internet phone apparatus can control the on/off operation of the biological analysis device, display an operational status of the biological analysis device, displays measured data in terms of a numerical value or a graph, provide the remote medical diagnosis service by the virtual doctor or the remote doctor, provides the user with a medical examination via the internet after the user is authenticated by a user identification unit, or provide the user with a hopping medical diagnosis service. The virtual doctor resides as software in the internet phone apparatus and includes a guide unit to provide the user with guidelines and instructions as how to use the biological analysis device, and a diagnosis unit to output a diagnosis result by self-analyzing measured data using mathematical calculation.

The diagnosis unit may have functions of (i) displaying the diagnosis results, which are obtained by analyzing measurement data of the biological analysis device through mathematical calculations, on a medical service window in the form of a numerical value, a graph, or a step having a high-medium-low level by comparing the present measurement data with a cutoff level, (ii) informing the user of the diagnosis results using the message delivery unit, (iii) recording the diagnosis results to the RF IC, and (iv) storing the diagnosis results in the remote medical diagnosis server. Preferably, the internet phone apparatus may further include a hopping medical diagnosis service unit for mandatorily performing only periodic medical examinations by the remote doctor via a remote medical diagnosis, and for self-analyzing measurement data by the virtual doctor except for time of periodic medical examinations and informing the patient or the remote medical diagnosis server of the diagnosis results. The hopping medical diagnosis service unit controls the internet phone apparatus to stop the medical examinations of the virtual doctor if the periodic medical examinations are not performed or a predetermined period of time for the periodic medical examination has lapsed. That is, in order to receive the medical examinations from the virtual doctor, the user must perform the periodic medical examinations with the remote doctor. The hopping medical diagnosis service unit has a hopping medical diagnosis service function for mandatorily performing the remote medical diagnosis with the doctors even if the period is not the periodic medical examinations, if requested by the user, if abnormal conditions are detected by the virtual doctor, if the diagnosis service with the virtual doctor is performed over a predetermined number of times, or if a predetermined period of time (e.g., 6 months) has lapsed since the patient receives the last remote medical diagnosis service from the remote doctor. The details of the hopping medical diagnosis service, such as an interval of mandatory periodic medical examinations (periodic consultations), a limit on the number of continuous services by the virtual doctor, or a cutoff level, may vary according to a past disease history of the patient, a present disease history of the patient, an opinion of the doctor, sex, age, or disease, and preferably may be determined by the doctor. In the initial sign up stage, the details of the hopping medical diagnosis service may be set up as a default value and may vary based on the diagnosis result by the doctor whenever the remote medical diagnosis service is terminated. The interval of mandatory periodic medical examinations (periodic consultations) in the hopping medical diagnosis service may be 6 months, and the limit on the number of continuous services by the virtual doctor may be 10 to 30 times. The user identification unit may include a password identification device or a fingerprint identification device. Preferably, fingerprint identification software is used to automatically authenticate an identification of the user. The internet phone apparatus preferably operates the bio disc or the optical disc by allowing the disc drive to operate as the power of the internet phone apparatus is turned on even if the power of the user computer is turned off. The internet phone apparatus may include at least one selected from the group consisting of a power on/off button for the biological analysis device, a play button for the optical disc, a stop button and a search button. The internet phone apparatus may further include a power switch to turn on/off standby power of the biological analysis device. The internet phone apparatus may further include a slot or a tray allowing loading/unloading of the biochip and a biochip analysis device for measuring a reaction signal of the biochip and analyzing the reaction result. The biochip means a device performing a disease analysis, a nucleic acid hybridization analysis, a bio material analysis, an analysis for a patient's constitution for personalized medicine, a urea analysis, a blood analysis, an environmental pollution analysis device, a biochemical analysis, or an immunoassay. For instance, the biochip may include a DNA chip, a lab-on-a-chip, a protein chip, a rapid test kit or a test strip. Thus, the internet phone apparatus may include the biological analysis device including the bio disc drive and the biochip analysis device. The test strip is subject to the coloring process or the electrochemical process. The bio disc drive built in the internet phone apparatus can play or drive typical optical discs, such as DVD, CD, CD-R, CD-RW, or DVD-R. The internet phone apparatus may further include video and audio input/output ports for outputting the reproduction signal or inputting the recording signal of the optical disc. The bio disc drive of the internet phone apparatus can be operated as a stand alone type DVD player because the bio disc drive can drive the typical optical disc, such as DVD, CD, CD-R, CD-RW, or DVD-R, even if the user computer is not powered on. The internet phone apparatus may further include an earphone connection unit. The internet phone apparatus may further include a card reader or a medical coupon card reader for the payment of the remote medical analysis and the authentication of the electronic medical insurance card. A card insertion slot or a card insertion slit of the card reader may be formed on an outer peripheral portion of the internet phone apparatus. According to one embodiment of the present invention, the internet phone apparatus may have a central control unit including a sample detection unit, a bio disc validity checking unit, a biochip validity checking unit, an assay stop process unit, a medical information reading unit, an information access unit and a hopping medical diagnosis service unit. The internet phone apparatus can control and drive the biological analysis device and perform the remote medical diagnosis through the internet by converting the data provided from the biological diagnosis device into numerical values using an assay program. The internet phone apparatus may transmit the barcode of the bio disc, the product ID of the bio disc, the product ID of the bio disc drive, an animal RF ID, product ID of the medical device, and the measurement data obtained from the bio analysis device to the remote medical analysis server. The internet phone apparatus may further include a display unit to display the measurement result of the biological analysis device in terms of numbers, a graph, or a high-medium-low form, the diagnosis result of the biological analysis device, the usage status of the user for the biological analysis in real time, the charge list, or the medical data or medical prescription received from the doctor. The internet phone apparatus may include a function selection button selected from the group consisting of an assay start button to control an operation of the biological analysis device, an assay stop button, a power on/off button, an eject or unloading button, a remote transmittance button, a diagnosis result confirmation button, a charge list confirmation button, and a payment authorization button. For instance, the bio disc or the biochip loaded on the biological analysis device can be unloaded from the biological analysis device by the eject button or unloading button. When the analysis has been completed, the user clicks the remote transmittance button to transmit the measurement data to the doctor. The internet phone apparatus may further include a display unit for displaying the periodic examination time when the remote doctor or the remote medical diagnosis server transmits the periodic examination time to the internet phone apparatus.

According to an embodiment of the present invention, the internet phone apparatus includes an internet phone connected to a wired internet or a wireless internet to transmit/receive information related to a medical service or a voice signal, a slot or a tray allowing loading and unloading of the biochip onto the internet phone, and a biochip analysis device for controlling a bio sensor or a detector to analyze the reaction result of the loaded biochip.

According to an embodiment of the present invention, the internet phone apparatus includes an internet phone connected to a wired internet or a wireless internet to transmit/receive information related to a medical service or a voice signal, a tray allowing loading of the bio disc or the optical disc onto the internet phone, a motor for rotating the bio disc or the optical loaded on the tray, and a bio disc drive for controlling the motor.

According to an embodiment of the present invention, the internet phone apparatus includes an internet phone connected to a wired internet or a wireless internet to transmit/receive information related to a medical service or a voice signal, a tray connected to the internet phone through a connection unit to allow loading of the bio disc or the optical disc onto the internet phone, a motor for rotating the bio disc or the optical loaded on the tray, and a bio disc drive for controlling the motor.

The internet phone apparatus may include a monitor connected to the internet phone through the connection unit to provide a GUI screen.

According to an embodiment of the present invention, the internet phone apparatus includes an internet phone connected to a wired internet or a wireless internet to transmit/receive information related to a medical service or a voice signal, a monitor connected to the internet phone through the connection unit to provide a GUI screen and measurement data for the biological analysis device, a tray allowing loading of the bio disc or the optical disc into the monitor, a motor for rotating the bio disc or the optical loaded on the tray, and a bio disc drive for controlling the motor.

A biochip analysis device can be installed in the monitor.

According to an embodiment of the present invention, the internet phone apparatus includes a tray allowing loading of the bio disc or the optical disc, a motor for rotating the bio disc or the optical loaded on the tray, a fixing unit having a bio disc drive for controlling the motor therein, and an internet phone connected to the fixing unit through a wired internet or a wireless internet to transmit/receive information related to a medical service or a voice signal

The fixing unit may include a monitor connected to the internet phone through the wired connection unit or the wireless connection unit to provide a GUI screen for the biological analysis device.

A biochip analysis device can be installed in the fixing unit.

The internet phone apparatus may have a set top box of an IPTV (internet protocol television) therein.

The moving picture or the still image of the IPTV program provided through a high-speed network can be displayed on the monitor by means of the connection unit.

The IPTV is an internet-based television providing a VOD (video on demand) service thorough bidirectional communication, in which the high-speed internet is connected to the set top box of the IPTV to allow the user to select desired TV programs from the GUI screen.

The IPTV can be connected to a hospital server to display various remote medical diagnosis services on the GUI screen.

According to an embodiment of the present invention, the internet phone apparatus includes an internet phone connected to a wired internet or a wireless internet to transmit/receive information related to a medical service or a voice signal, a set top box connected to the internet phone through the connection unit to provide a GUI service and a IPTV service for the biological analysis device, a tray allowing loading of the bio disc or the optical disc into the internet phone or the set top box, a motor for rotating the bio disc or the optical loaded on the tray, and a bio disc drive for controlling the motor.

According to the present invention, the internet phone apparatus may further include a mouse connected to the connection unit to select a menu from the GUI screen, a keyboard, a portable device or a remote controller.

According to an embodiment of the present invention, there is provided a remote medical service method including the steps of obtaining measurement data using a bio analysis device or a medical device, accessing a remote doctor or a virtual doctor providing the remote medical service, and transmitting the measurement data to the remote doctor or a remote medical diagnosis server. The remote medical service method may further include a step of analyzing the measurement data by the remote doctor and informing a user of a diagnosis result through a message delivery unit. Preferably, the message delivery unit may include an email and a text message of a portable phone. The remote medical service method may further include a step of informing a period of time for a periodic examination to the internet phone apparatus through the remote doctor or the remote medical diagnosis server. The remote medical service method may further include a step of reading a product ID of a bio disc or a bio disc driver. The remote medical service method may further include a step of authenticating the product ID by transmitting the product ID to the web site server.

The remote medical service method may further include a step of upgrading the internet phone apparatus by downloading a driving software including a protocol and an assay algorithm corresponding to the product ID through an internet. The remote medical service method may further include a step of displaying the measurement data. The remote medical service method may further include a step of assigning a control right for the internet phone apparatus to the remote doctor.

The remote medical service method may further include a step of performing a medical diagnosis by the virtual doctor.

The remote medical service method may further include the steps of informing a user of the diagnosis result by self-analyzing the measurement data measured from the biological analysis device using diagnosis software, and storing the measurement data and diagnosis results or transmitting the measurement data and diagnosis results to the remote medical diagnosis server.

The remote medical service method may further include a step of displaying contents or a schedule of a hopping medical diagnosis service. The remote medical service method according to the present invention may include a periodic medical examination for transmitting the measurement data to the remote doctor during the time of the periodic medical examination and requesting the remote doctor to diagnose and evaluate the measurement data, and a non-periodic medical examination, which is performed during the time except for the periodic medical examinations, for requesting the virtual doctor to diagnose and evaluate the measurement data.

### Advantageous Effects of Invention

The internet phone apparatus including the biological analysis device built therein and the remote medical service method using the same according to the embodiment of the present invention can realize the effective remote medical diagnosis.

### BRIEF DESCRIPTION OF DRAWINGS

FIG. 1 is a view showing a bio disc and a biological analysis device for driving and controlling the bio disc according to an embodiment of the present invention;

FIG. 2 is a plan view showing a slider equipped with a BOPM and a valve opening/closing unit shown in FIG. 1 according to an embodiment of the present invention;

FIG. 3 is a side view showing a bio disc drive for driving and controlling a bio disc shown in FIG. 1 according to an embodiment of the present invention;

FIGS. 4 to 6 are views showing examples of an internet phone apparatus equipped with a bio disc drive for driving a bio disc;

FIG. 7 is a view showing a user computer, which provides a graphic user interface for controlling a bio analysis device built in an internet phone apparatus and is connected to an input/output unit of the internet phone apparatus through a USB cable;

FIG. 8 is a view showing an internet phone apparatus, which provides a graphic user interface and is connected to a monitor and a mouse through an input/output unit;

FIG. 9 is a perspective view showing an internet phone apparatus, which is divided into a fixing unit having a biological analysis device therein and a portable device having a mounting member; and

FIGS. 10 and 11 are views showing graphic user interface screens of the internet phone apparatus according to an embodiment of the present invention.

### BEST MODE FOR CARRYING OUT THE INVENTION

Hereinafter, exemplary embodiments of the present invention will be described in detail with reference to the accompanying drawings.

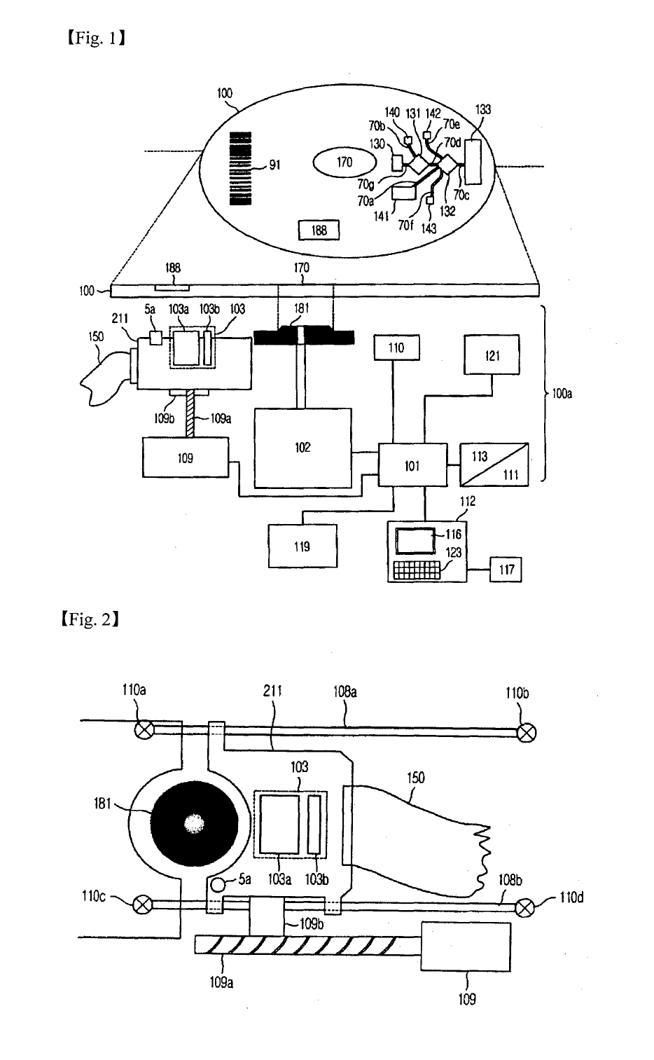

FIG. 1 is a view showing a bio disc and a biological analysis device for driving and controlling the bio disc according to an embodiment of the present invention.

Referring to FIG. 1, the bio disc 100 is obtained by integrating a lab on a chip into a disc device such as a typical CD-ROM and DVD.

In detail, FIG. 1 shows the bio disc 100 integrated with chambers storing various buffer solutions required for the analysis and performing various chemical processes, channels for migrating fluids between the chambers, and valves 70a to 70g for opening and closing holes (not shown) that connect the channels with each other; and a bio disc drive 100a for controlling and driving the bio disc 100. Reference numeral 170 represents a disc gap and reference numeral 91 represents a barcode including information about a product ID of the bio disc, a term of validity, and a sort of diseases to be analyzed or diagnosed. The bio disc may include at least one of a preparation chamber 130 for preparing a specimen from a sample, a buffer chamber 131 amplifying the specimen, temporarily storing the specimen obtained from the preparation chamber or storing a dilution buffer for diluting the specimen or a label bound with target material in the specimen, an assay site 132 performing the biological or biochemical reaction with the specimen and to which a capture probe performing the specific binding reaction with the specimen is fixed, specimen chambers 140, 141 and 142 storing an enzyme or a buffer solution required for the analysis, a trash chamber 133 collecting trashes after the cleaning process, and a cleaning chamber 143 storing a cleaning solution required for the cleaning process. Reference numerals 130, 131, 132 and 133 represent process chambers, and reference numerals 140, 141, 142 and 143 represent reagent chambers. The reagent chambers may store the buffer solution including various enzymes, such as polymerase and primer. In addition, the reagent chamber may store various enzymes required for the hybridization and the cleaning solution required for the cleaning process. Reference numeral 211 represents a slider equipped with a movable valve opening/closing unit for opening/closing the valves 70a to 70g. The slider is connected to a slide motor 109 such that the operation of the slider can be controlled by the slider motor 109. At the start and end points of each process (preparation process, amplification process, hybridization process and cleaning process), the opening/closing of the valves is controlled by moving the valve opening/closing unit 5a installed on the slider 211 to the center of the hole of the appropriate valve.

Reference numeral 103a represents an optical pickup device for reproducing a typical optical disc (CD or DVD), and reference numeral 103b represents a detector or a bio sensor used for the quantitative analysis or the qualitative analysis of the assay site 132. The detector or the bio sensor may include a light transmittance measurement device, a fluorescence detection device, a noctilucence detection device, an image sensor device, a bio fit detection device, a spectrometer, or an SPR (Surface Plasmon Resonance). The optical pickup device 103a and the detector or the bio sensor 103b may constitute a bio optical pickup module (BOPM) 103. The BOPM 103 is mounted on the slider to enable the space addressing with respect to the valve and the movement of the BOPM 103 is controlled by the slider motor 109. A laser beam transceiver and the valve opening/closing unit 5a are mounted on the BOPM 103, and the coordinate of the BOPM 103 is controlled by the slide motor 109, so that the opening and closing of the valves can be selectively, individually and independently controlled. Preferably, the optical pickup device 103a may serve as the laser beam transceiver.

According to the present invention, preferably, the valve opening/closing unit 5a includes a permanent magnet. The permanent magnet 5a moves in the radial direction or moves based on a two-dimensional coordinate (radial direction and azimuthal direction) or a three-dimensional coordinate (radial direction, azimuthal direction and up/down direction) under the control of the slider. Preferably, the movement in the radial direction is achieved under the control of the slide motor 109. Preferably, the movement in the azimuthal direction is achieved by rotating a disc within a short period of time using the spindle motor or a step motor while stopping the movement of the slider. To realize the movement in the azimuthal direction of the disc, the step motor is preferably coupled to the motor shaft of the spindle motor through a gear. The up/down movement of the slider or the permanent magnet 5a is preferably limited by a gear coupling unit connected to the motor.

Reference numeral 150 represents a flexible cable for providing various control signals required for the BOPM 103 mounted on the slider 211. The flexible cable is connected to the central control unit 101. Reference numeral 181 represents a turntable on which the bio disc 100 is loaded through a front loading scheme or a top loading scheme while matching a center hole 170 of the bio disc 100 with the center of the turntable. Reference numeral 102 represents a spindle motor for rotating the bio disc. Reference numeral 188 represents a RF IC with a built-in memory or an electronic tag device. The RF IC or the electronic tag device may include at least one of a protocol for a lab on a chip process, analysis algorithm, standard control values for reading, position information for the assay site, bioinformatics information, self diagnosis, and information related to the analysis result with respect to the assay site for the bio disc. In addition, personal ID information or a product ID of a bio disc can be stored in the RF IC or the electronic tag device to prevent the access of a third party. The RF IC 188 preferably includes a smart IC card. Information of the RF IC 188 is transmitted to the central control unit 101 through the wireless or wired scheme such that the information can be utilized for personal encryption and authentication of the bio disc. Reference numeral 110 is a wireless wave generator or a permanent magnet for supplying power to the RF IC 188. The wave generated from the wireless wave generator activates the induction coil accommodated in the RF IC 188 according to the Fleming's Law so that a great amount of electricity is supplied to the RF IC 188. A memory unit 113 and an input/output unit 111 are installed in the bio disc drive. The memory unit 113 stores measurement data and product information including a version, a date of manufacture, and a product ID of the biological analysis device. The input/output unit 111 serves as a wired connection unit or a wireless connection unit. Reference numeral 112 is an internet phone connected to the internet through an internet connection terminal 117 to transmit/receive medical service information or the voice signal. The internet phone 112 has a display device 116. Reference numeral 119 is a biochip analysis device. Reference numeral 121 is a barcode reader, a card reader or an RF ID reader. Reference numeral 123 represents a button unit. The button unit may include at least one function selection button selected from the group consisting of an assay start button to control an operation of the biological analysis device, an assay stop button, a power on/off button, an eject or unloading button, a remote transmittance button, a diagnosis result confirmation button, a charges list confirmation button, and a payment authorization button. Software resides in the central control unit 101 to drive a sample detection unit, a bio disc validity checking unit, a biochip validity checking unit, an assay stop process unit, a medical information reading unit, an information access unit, and a hopping medical diagnosis service unit. Reference numerals 109a and 109b are worm gear coupling sections connected to a shaft of the slide motor 109.

FIG. 2 is a plan view showing the slider equipped with the BOPM 103 and the valve opening/closing unit 5a shown in FIG. 1 according to an embodiment of the present invention. The movement of the slider is controlled by worm gear coupling sections 109a and 109b connected to the shaft of the slide motor 109. The slider slidably moves while being guided by slide arms 108a and 108b. The slide arms 108a and 108b are fastened to the body of the bio disc drive 100a through screws 110a to 110d. Reference numeral 181 represents the turntable rotated by the spindle motor 102.

FIG. 3 is a side view showing the bio disc drive 100a for driving and controlling the bio disc 100 shown in FIG. 1 according to an embodiment of the present invention.

Reference numeral 300 represents a body that supports the bio disc drive 100a. A circuit board 390 is fastened to the body 300 of the bio disc drive 100a at the bottom of the bio disc drive 100a. Provided on the circuit board 390 are the central control unit 101 for controlling the bio disc drive 100a, the memory unit 113 for storing measurement data and product information including a version, a date of manufacture, and a product ID of the biological analysis device, and the input/output unit 111 serving as a wired connection unit or a wireless connection unit. The central control unit 101 controls the spindle motor 102 to rotate or stop the bio disc 100 and controls the movement of the BOPM 103 mounted on the slider 211 under the control of the slide motor 109. In addition, the central control unit 101 moves the position of the valve opening/closing unit 5a to control the opening/closing operation of the valves of the bio disc 100.

According to the present invention, preferably, the valve opening/closing unit 5a is moved closely to the center of the hole of the valve in such a manner that the valve can be open through magnetic interaction (repulsive force or attractive force). In addition, the central control unit 101 determines whether the disc currently loaded in the bio disc drive 100a is a typical optical disc (for instance, music CD, CD-R, game CD or DVD) or the bio disc 100. If the disc is the typical optical disc, the central control unit 101 transmits information read from the typical optical disc using the optical pickup device 103a to the memory unit 113 or the input/output device 111. In addition, the central control unit 101 transmits information to be written to the optical pickup device 103a and provides various read/write control signals to the above elements. If the disc is the bio disc 100, the central control unit 101 transmits various control command signals to the above elements to control the lab on chip process.

According to the present invention, preferably, at the time of loading the bio disc, the ID of the bio disc is transmitted to the central control unit in a wireless manner through the RF IC 188, so that the central control unit 101 can recognize that the disc loaded in the bio disc drive 100a is the bio disc.

According to the present invention, preferably, the reading result for the assay site 132 obtained from the assay site reading device 103b on the BOPM is transmitted to the central control unit 101, the memory device 113 or the input/output device 111 through the flexible cable 150 connected to the slider 211. Reference numeral 104 is a pressing unit for the bio disc 100 loaded in the disc gap. The pressing unit presses the disc through the magnetic attraction with the turntable 181 and is designed to perform the vertical movement or idle rotation.

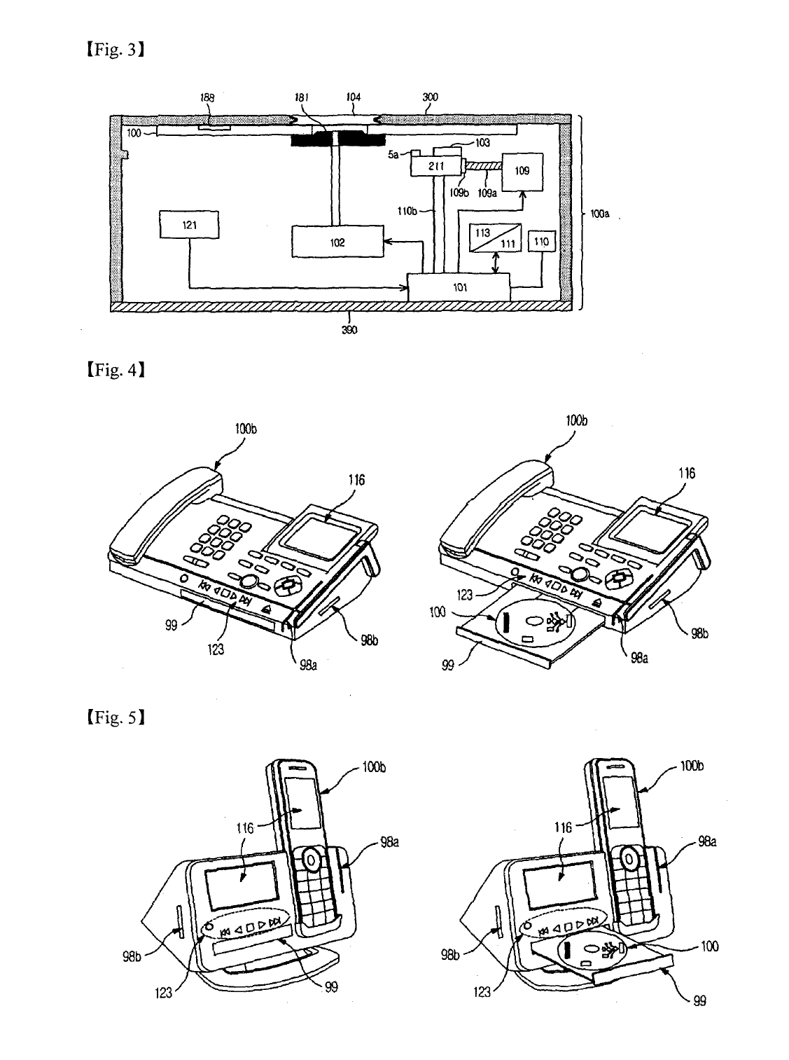

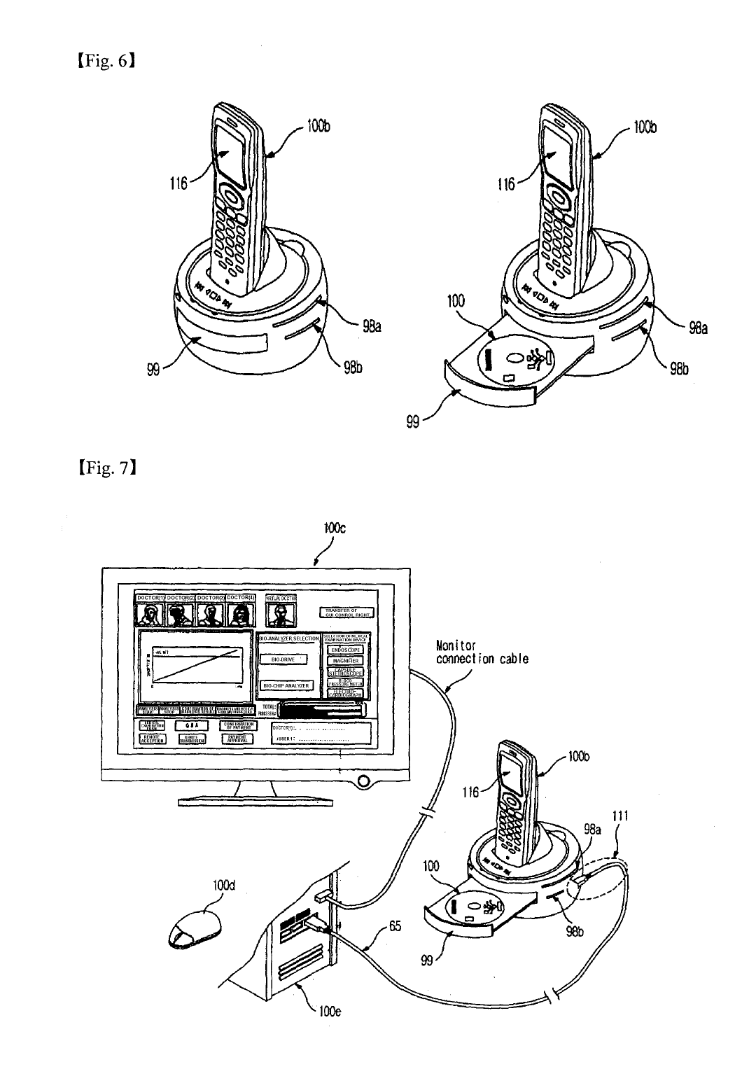

FIGS. 4 to 6 are views showing examples of the internet phone apparatus equipped with a bio disc drive for driving a bio disc. FIGS. 4B, 5B and 6B show the tray 99 ejected for loading the bio disc 100. FIGS. 4 to 6 show the internet phone apparatus including an internet phone 100b connected to a wired internet or a wireless internet to transmit/receive information related to a medical service or a voice signal and a tray 99 allowing loading of the bio disc 100 or the optical disc. Reference numeral 98a is a card insertion hole or a card insertion slot of the card reader or a medical coupon card reader used for the payment of the remote medical analysis and the authentication of the electronic medical insurance card. Reference numeral 98b is a slot or a tray allowing the loading/unloading of the biochip. Reference numeral 123 is a button unit. The button unit may include at least one function selection button selected from the group consisting of an assay start button to control an operation of the biological analysis device, an assay stop button, a power on/off button, an eject or unloading button, a remote transmittance button, a diagnosis result confirmation button, a charges list confirmation button, and a payment authorization button. Reference numeral 116 is a display device which can be served as a display device of the internet phone 100b. In addition, when the internet phone 100b is mounted on the internet phone apparatus, the battery of the internet phone 100b is charged.

FIG. 7 is a view showing a user computer 100e, which provides a graphic user interface (GUI) for controlling the bio analysis device built in the internet phone apparatus and is connected to the input/output unit 111 of the internet phone apparatus through a USB cable 65. The user computer 100e transmits the control command to the internet phone apparatus through the USB cable 65 to control and drive the biological analysis device.

The GUI screen is displayed on a monitor 100c and the biological analysis device is operated as the user selects the menu from the GUI screen by using a mouse 100d.

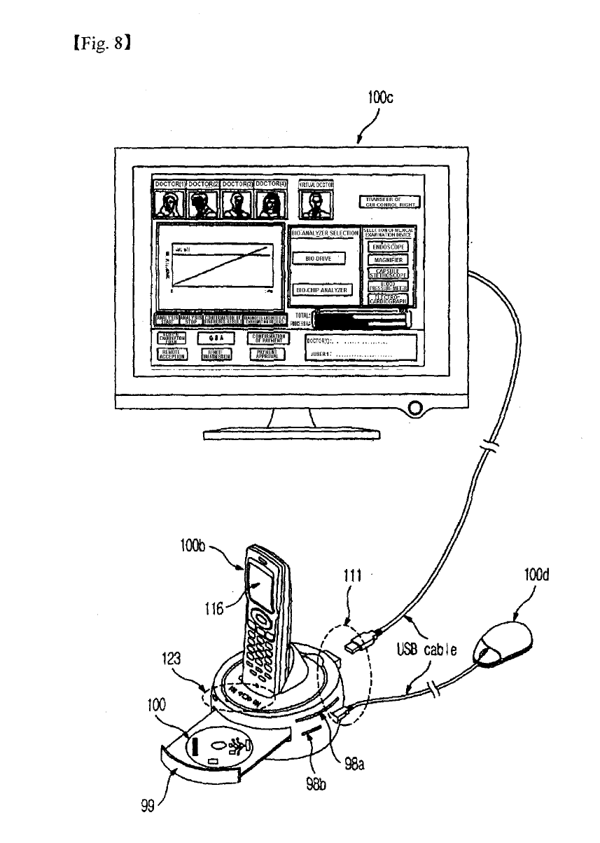

FIG. 8 is a view showing the internet phone apparatus, which provides the GUI and is connected to the monitor 100c and the mouse 100d through the input/output unit 111.

The GUI screen provided from the internet phone apparatus is displayed on the monitor 100c and the biological analysis device is operated as the user selects the menu from the GUI screen by using a mouse 100d.

FIG. 9 is a perspective view showing the internet phone apparatus, which is divided into a fixing unit 300a having the biological analysis device therein and a portable device 300b having a mounting member. An antenna 97 of the fixing unit 300a may serve as a wireless communication unit between portable terminals. The antenna 97 transmits the data to the portable device 300b by processing the data received through the internet cable or transmits the data to the internet cable by removing the data from the portable device 300b. The fixing unit 300a is provided with the card insertion hole or the card slit 98a, the slot 98b allowing the loading/unloading of the biochip, the button unit 123, and the display device 116.

The fixing unit 300a may further include a monitor connected to the wired connection unit or the wireless connection unit to provide the GUI screen for the biological analysis device.

FIG. 9B shows the tray 99 ejected for loading the bio disc 100.

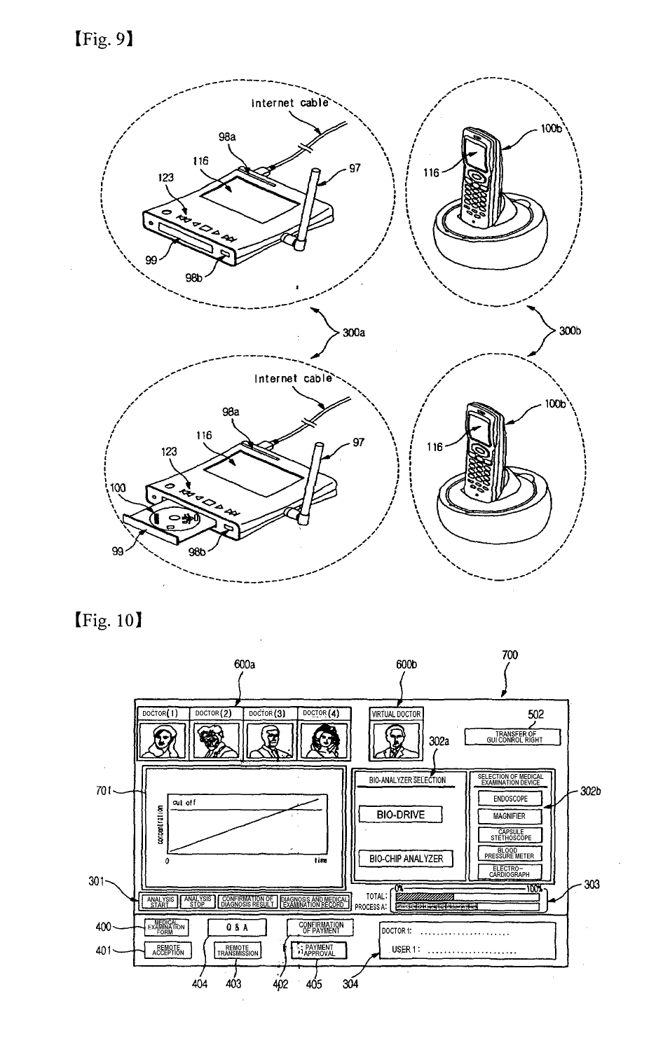

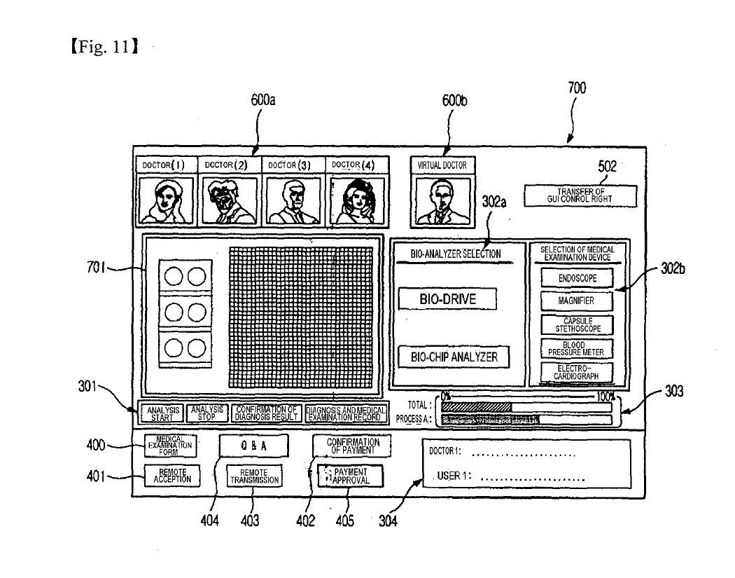

FIGS. 10 and 11 are views showing a GUI screen 700 of the internet phone apparatus according to an embodiment of the present invention. The GUI screen 700 may include various buttons and windows for allowing the user to easily access the GUI screen 700. Doctor selection windows 600a and 600b are provided at the upper portion of the GUI screen 700 to allow the user to select the doctors or the virtual doctor. Reference numeral 301 represents a button panel having the function selection buttons. Reference numeral 303 is a progress rate display window for displaying the progress rate of the biological analysis device. Reference numeral 302a represents a panel having buttons for selecting the biological analysis device to be used and reference numeral 302b represents a panel having buttons for selecting the medical device to be used. Reference numeral 304 is a chatting window for making communication using letters or characters. Reference numeral 701 is a medical service window for displaying the measurement data of the biological analysis device and the medical device in terms of a numeral value, a graph or a step having a high-medium-low level, displaying the diagnosis results of the biological analysis device and the medical device, displaying the medical check list and Q&A, displaying the charge list, displaying the medical data or medical prescription received from the doctors, displaying ten keys and an image of the counterpart when making communication with the counterpart, and displaying information for the user by using the message delivery unit. In addition, the GUI screen 700 includes a remote transmittance button 403 for transmitting the measurement data, the medical check list, Q&A, information about diagnosis history, or medical data to the remote medical analysis server or the remote doctor, a remote receiving button 401 for receiving the diagnosis result, medical prescription, check list, Q&A, medical data, or charge lists from the remote medical analysis server or the remote doctor, a charge list confirmation button 402 for confirming the charge, a payment authorization button 405 for authorizing the payment for the remote medical diagnosis service by using an electronic money, a card or a cell phone number, a medical check list button 400 for editing or displaying the medical check list, a Q&A button 404 for writing and displaying the Q&A, and a control right assignment button 502 for assigning the remote control right for the internet phone apparatus to the remote doctor selected by the user.

If the remote control right is assigned to the remote doctor, the remote doctor can control the biological analysis device of the internet phone apparatus in real time. Thus, remote doctor can easily provide the medical service to the user even if the user is not accustomed with the biological analysis device. The user may have the right for the payment authorization even when the remote control right is assigned to the remote doctor.

FIG. 10 shows the medical service window 701, in which the measurement data previously obtained are displayed on the medical service window 701 using a graph with a cutoff level. The cumulative data previously obtained significantly contributes to early detection of a disease and a reduction in the misdiagnosis rate since a disease can be traced and tracked.

FIG. 11 shows the measurement data, which are measured by the biochip analysis device, displayed on the medical service window 701.

Although embodiments have been described with reference to a number of illustrative embodiments thereof, it should be understood that numerous other modifications and embodiments can be devised by those skilled in the art that will fall within the spirit and scope of the principles of this disclosure. More particularly, various variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

1. An internet phone apparatus comprising:
an internet phone connected to a wired internet or a wireless internet to transmit/receive information related to a medical service or a voice signal;
a biological analysis device including a biochip analysis device for analyzing a biochip and a bio disc drive for analyzing a bio disc;
a remote medical diagnosis server which relays connection between a remote doctor and the biological analysis device through the internet phone, between a hospital server and the biological analysis device through the internet phone, or between a computer of the remote doctor and the biological analysis device through the internet phone;
a tray allowing loading of the bio disc or an optical disc;
a motor for rotating the bio disc or the optical disc loaded in the tray; and
a central control unit for controlling the biological analysis device.

2. The internet phone apparatus as claimed in claim 1, wherein the biochip analysis device analyzes at least one of a DNA chip, a lab-on-a-chip, a protein chip, a rapid test kit and a test strip.

3. The internet phone apparatus as claimed in claim 1, wherein the biochip analysis device includes a slot or a tray allowing loading/unloading of the biochip.

4. The internet phone apparatus as claimed in claim 1, further comprising a barcode reader for reading a barcode provided in the bio disc or the biochip.

5. The internet phone apparatus as claimed in claim 1, further comprising an RF reader for reading an ID and contents of an RF IC provided in the bio disc or the biochip.

6. The internet phone apparatus as claimed in claim 1, further comprising a virtual doctor residing as software in the internet phone apparatus and including a guide unit to provide a user with guidelines and instructions as how to use the biological analysis device, and a diagnosis unit to output a diagnosis result by self-analyzing measured data using mathematical calculation.

7. The internet phone apparatus as claimed in claim 5, wherein the RF reader includes:
an authentication unit for authenticating the biochip or the bio disc, or personally encrypting the biochip or the bio disc; and
a recording unit for recording measurement data of the bio disc or the biochip in the RF IC.

8. The internet phone apparatus as claimed in claim 7, wherein the recording unit receives a cumulative history of past diagnosis results made by the virtual doctor or the remote doctor from the remote medical diagnosis server and saves the cumulative history into the RF IC.

9. The internet phone apparatus as claimed in claim 1, further comprising a memory unit for storing measurement data obtained from the biological analysis device and product information selected from the group consisting of a version, a date of manufacture, and a product ID of the biological analysis device.

10. The internet phone apparatus as claimed in claim 9, wherein the product ID of the biological analysis device stored in the memory unit is provided to the remote medical diagnosis server through an internet network for product authentication of the biological analysis device.

11. The internet phone apparatus as claimed in claim 10, wherein the bio disc or the biochip is authenticated by the biological analysis device that passes the product authentication.

12. The internet phone apparatus as claimed in claim 1, further comprising an interface unit that enables connection to a local server for remote communication, a home network system or a home network system cooperating with household appliances.

13. The internet phone apparatus as claimed in claim 1, further comprising a user computer connected through a wired connection unit or a wireless connection unit to provide a graphic user interface (GUI) for controlling the biological analysis device.

14. The internet phone apparatus as claimed in claim 13, wherein the connection unit is selected from the group consisting of a universal serial bus, infrared communication, RF communication, a wired/wireless internet, a fixing unit providing the wired/wireless internet, and a Bluetooth.

15. The internet phone apparatus as claimed in claim 13, further comprising a medical device built in the internet phone apparatus or connected to the internet phone apparatus through the wired/wireless connection unit to make communication with the internet phone apparatus.

16. The internet phone apparatus as claimed in claim 15, wherein the medical device includes at least one of a thermometer used for medical examination and treatment, a sphygmomanometer, a camera, a stethoscope, a body composition analyzer, an arteriosclerosis detector, an ultrasonic scanning apparatus, an urianalyzer, a pulse monitor, a blood sugar meter, a blood sampling device, an electrocardiogram, an X-Ray apparatus, an oxymeter, a dementia detecting apparatus, a computerized axial tomography (CAT) apparatus, a magnetic resonance imaging (MRI) apparatus, a capsule endoscopy, a magnifier, a magnifier with a camera, a medical instrument, a bio signal detecting apparatus, and a bio shirt having a function of detecting a bio signal (diabetes, obesity, blood pressure, pulse, an electrocardiogram, body temperature, or the like).

17. The internet phone apparatus as claimed in claim 15, wherein the GUI includes a control assignment button to assign a remote control right for the biological analysis device to the remote doctor.

18. The internet phone apparatus as claimed in claim 5, further comprising a medical information reading unit which reads information from the RF IC or the remote medical diagnosis server and provides a user with the information selected from the group consisting of a type, a version, a date of manufacture, and a validity period of the bio disc or the biochip loaded on the biological analysis device, a diagnosable disease list, user precautions, details of a history management list, medical data, and next examination date.

19. The internet phone apparatus as claimed in claim 5, further comprising an information access unit which transmits a product ID or a product serial number read from the RF IC of the bio disc or the biochip loaded on the biological analysis device to the remote medical diagnosis server, and receives information corresponding to the product ID or the product serial number from the remote medical diagnosis server to provide a user with the information selected from the group consisting of a type, a version, a date of manufacture, and a validity period of a product, a diagnosable disease list, user precautions, details of a history management list, medical data, and next examination date.

20. The internet phone apparatus as claimed in claim 5, wherein diagnosis results made by the remote doctor and a virtual doctor and an ID of the remote doctor are stored in the RF IC.

21. The internet phone apparatus as claimed in claim 1, wherein the central control unit controls on/off operations of the biological analysis device, displays an operational status of the biological analysis device, displays measurement data of the biological analysis device in terms of a numerical value or a graph, provides a user with a remote medical diagnosis service made by a virtual doctor or the remote doctor, or authenticates a member by using a user identification unit.

22. The internet phone apparatus as claimed in claim 6, wherein the central control unit includes a hopping medical diagnosis service unit for mandatorily performing periodic medical examinations by the remote doctor, and for self-analyzing measured data by the virtual doctor during the time except for the periodic medical examinations and informing a patient or the remote medical diagnosis server of the diagnosis result.

23. The internet phone apparatus as claimed in claim 22, wherein the hopping medical diagnosis service unit stops the medical examinations by the virtual doctor if the periodic medical examinations are not performed or a predetermined period of time for the periodic medical examination has lapsed.

24. The internet phone apparatus as claimed in claim 1, further comprising at least one selected from the group consisting of a play button, a stop button, and a search button.

25. The internet phone apparatus as claimed in claim 1, further comprising at least one function selection button selected from the group consisting of an assay start button to control an operation of the biological analysis device, an assay stop button, a power on/off button, an eject or unloading button, a remote transmittance button, a diagnosis result confirmation button, a charges list confirmation button, and a payment authorization button.

26. The internet phone apparatus as claimed in claim 1, wherein the central control unit includes at least one selected from the group consisting of a sample detection unit, a bio disc validity checking unit, a biochip validity checking unit, and an assay stop process unit.

27. The internet phone apparatus as claimed in claim 1, further comprising a set-top box of an internet protocol television.

28. A remote medical service method comprising:
providing an internet phone apparatus as claimed in claims 1 to 15;
obtaining measurement data using the bio analysis device or the medical device;
installing a program related to the remote medical service in a user computer;
accessing a remote doctor or a virtual doctor providing the remote medical service; and
transmitting the measurement data to the remote doctor or a remote medical diagnosis server.

29. The remote medical service method as claimed in claim 28, further comprising at least one selected from the group consisting of:
analyzing the measurement data by the remote doctor and informing a user of a diagnosis result through a message delivery unit;
informing a period of time for a periodic medical examination to the internet phone apparatus through the remote doctor or the remote medical diagnosis server;
reading a product ID of the bio disc or the bio disc driver;
authenticating the product ID by transmitting the product ID to the remote medical diagnosis server;
upgrading the internet phone apparatus by downloading a driving software including a protocol and an assay algorithm corresponding to the product ID through an internet;
displaying the measurement data on a screen of a graphic user interface;
assigning a control right for the internet phone apparatus to the remote doctor;
storing the measurement data and diagnosis results made by the virtual doctor or transmitting the measurement data and diagnosis results to the remote medical diagnosis server; and
displaying a schedule of a hopping medical diagnosis service.
